(19) United States
(12) Patent Application Publication
(10) Pub. No.: US 2006/0155659 A1
(43) Pub. Date: Jul. 13, 2006

(54) Method and system for promoting fan identification with a sports team

(76) Inventor: Vincent DiCesare, Lynnfield, MA (US)

Correspondence Address: McCormick, Paulding & Huber LLP, CityPlace II, 185 Asylum Street, Hartford, CT, 06104-3402, US

(21) Appl. No.: 10/995,577

(22) Filed: Nov. 23, 2004

(51) Int. Cl. G06F 17/00

(52) U.S. Cl. 705/500

(57) ABSTRACT

A system and method for promoting fan identification with a sports team is provided. The method including the steps of identifying a group of fans of a sports team, selecting a unique identifier corresponding to each of the fans of the group and offering to each fan of the group a personalized article related to the sports team or an event associated therewith. Each of the personalized articles bearing indicia corresponding to the unique identifier associated with the offeree fan. The method further includes providing the personalized articles to each fan of the group accepting the offer. A computer system for carrying out the method of the invention is also provided.

### FIELD OF THE INVENTION

The present invention generally relates to promoting fan identification with a sports team. More particularly, the present invention is directed to a method and system for identifying a group of fans of a sports team and offering to each fan of the group a personalized article related to the sports team or an event associated therewith. Each of the personalized articles bearing unique indicia corresponding to the offeree fan.

### BACKGROUND OF THE INVENTION

In general, the success of a sports team depends largely on the support of the fans of the sports team. For example, teams with a larger fan base and greater fan support often fair better than those in smaller markets or with fewer fans. Certainly, the quality and skill of the players is a factor related to the success of a team, however, the sports teams with the most fans usually attract and can afford the best players. Thus, attracting new fans as well as maintaining existing fans is an important part of managing any sports team and is often the subject of competition between sports teams or sports organizations. For example, in large cities having more than one professional sports team, the competition for fans between the sports teams can be much greater than in smaller cities with fewer teams.

One factor related to maintaining a fan base is the level of fan identification with a particular sports team. Fan identification can be generally described as the personal commitment and emotional involvement customers have with a sports organization or team. Characteristics of the players and the organization of a sports team as well as the amount of involvement and exposure the sports team has in a community, all contribute to influence the level of fan identification with the sports team. The higher the level of fan identification, the more likely fans are to attend the team's games or events or support the team through the purchase of goods associated with the sports team.

In the National Football League (NFL) for example, most of the tickets to the games are sold out to season ticket holders. Accordingly, increasing fan identification with an NFL team often requires more than promoting ticket sales. One method of promoting fan identification with a sports team is through establishing and/or maintaining communications with season ticket holders of the sports team. Targeted marketing campaigns directed to season ticket holders or other fans of a sports team is known in the industry. Often, however, merchandise offered to season ticket holders through targeted marketing campaigns is usually merchandise that is readily available through other sources and often at lower prices.

Based on the foregoing, it is the general object of the present invention to provide a method and system for promoting fan identification with a sports team that improves upon, or overcomes the problems and drawbacks associated with prior art methods.

### SUMMARY OF THE INVENTION

The present invention offers advantages and alternatives over the prior art by providing a method and system for promoting fan identification with a sports team. The method includes identifying a group of fans of a sports team and selecting a unique identifier for each of the fans of the group. Each of the fans of the group are offered a personalized article related to the sports team or an event associated with the sports team and bearing indicia corresponding to the unique identifier associated with that particular fan of the group. The personalized articles are provided to each fan of the group accepting the offer.

The personalized articles can be commemorative articles directed to a particular event or achievement of the sports team such as a division championship, Super Bowl or World Series championship. In accordance with one embodiment of the present invention, the personalized article is a Super Bowl Championship ring personalized with the name and seat number for each of the season ticket holders of a championship team.

In one embodiment of the method of the present invention, the group of fans is the season ticket holders of a professional sports team. Alternatively, the group of fans can be any group of fans related to the sports team, (e.g., a fan club the present invention, the group of fans are the season ticket holders of the sports team associated with a particular section of a home stadium of the sports team.

The present invention further includes a computer system for carrying out the method of the invention. The computer system includes a computer processor having a database and an output device coupled to the computer. The database contains stored information related to a group of fans of the sports team. In one embodiment of the invention, the group of fans includes the season ticket holders of a professional sports team. Thus, the database contains identification and contact information for each of the season ticket holders as well as information regarding the seat(s) or suites allocated to each of the season ticket holders. The computer system also includes a software application for processing data corresponding to a group of fans of the sports team and generating offers to be presented to each fan of the group for offering a personalized article related to the sports team or an event associated with the sports team. The computer processor includes software for processing sales transactions for the purchase of the personalized articles.

Accordingly, the present invention provides a method and system for promoting fan identification with a sports team by offering to and providing personalized articles related to the sports team to certain fans of the sports team whereby the fans of the sports team can further identify themselves with the sports team.

### BRIEF DESCRIPTION OF THE DRAWINGS

FIG. 1 is a flow chart illustrating an exemplary overview of the method of the present invention.

FIG. 2 is an illustration of a group of fans of a sports team identified in accordance with the present invention.

FIG. 3 is an illustration of one example of a personalized article in accordance with the present invention.

FIGS. 4 and 5 are a flow chart illustrating a preferred embodiment of the method of the present invention.

FIG. 6 is an illustration of a list of season ticket holders of a professional sports team identified as a group in accordance with the present invention.

FIG. 7 is a schematic diagram of one example of a computer system in accordance with the present invention.

### DETAILED DESCRIPTION OF THE INVENTION

Referring to FIG. 1, a flow chart of an overview of the method for promoting fan identification with a sports team in accordance with the present invention is shown generally at 10. The method 10 of the present invention is typically carried out and utilized by a sports team for the purpose of increasing the level of fan identification with the sports team. However, a third party could also utilize the method of the present invention on behalf of a sports team.

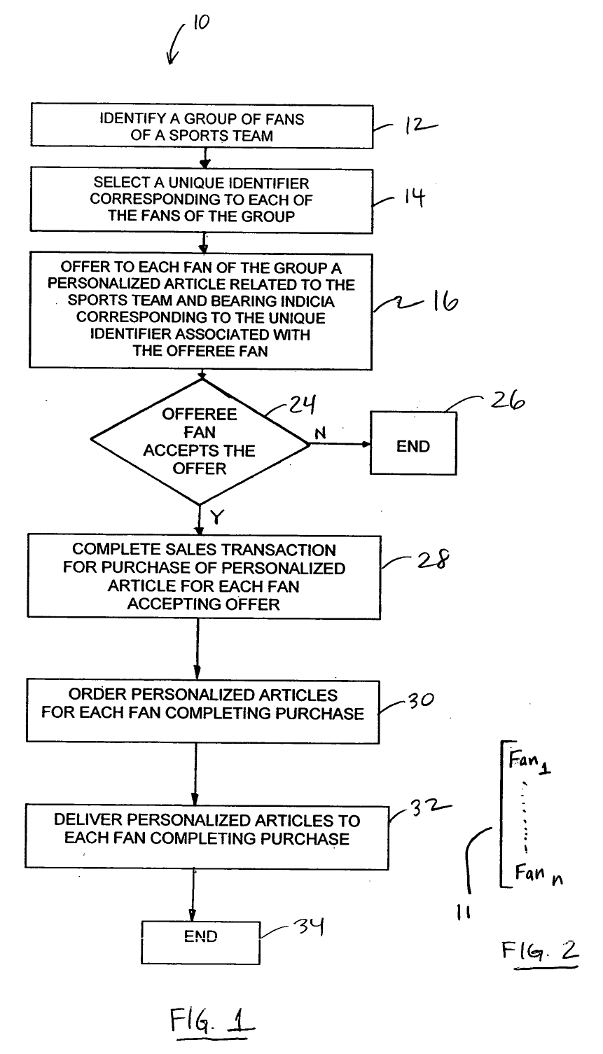

The method for promoting fan identification with a sports team 10 begins at block 12 wherein a group of fans 11 (shown in FIG. 2) of a sports team are identified. In a preferred embodiment of the present invention, the group of fans 11 are season ticket holders of the sports team. Alternatively, the group of fans 11 identified can be other known fans of the sports team, including fans listed on a mailing list of the sports team or fans belonging to one or more fan clubs associated with the sports team. In a further embodiment, the group of fans 11 identified at block 12 are fans solicited for the purpose of identifying a group of fans 11. For example, the group of fans 11 could be identified through a selection process such as a contest or lottery.

Additionally, the group of fans 11 can include one or more corporate sponsors or corporations that advertise during team games or team sponsored events or otherwise lease advertising space from the sports team 10. Further, in other embodiments of the method of the invention, the group of fans 11 includes individuals or corporations who lease or own private boxes or designated areas of a stadium associated with the sports team 10.

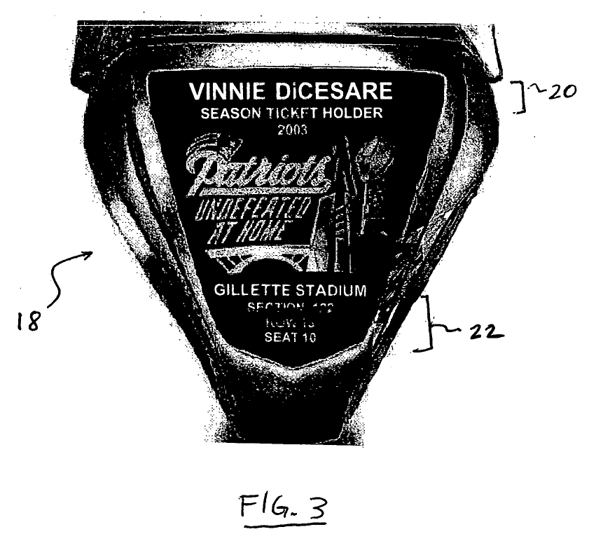

Once the group of fans 11 have been identified, the method 10 continues at block 14 wherein a unique identifier is selected corresponding to each fan of the group. At block 16, each fan of the group of fans 11 is offered a personalized article related to the sports team or a particular event associated with the sports team and bearing indicia corresponding to the unique identifier associated with the offeree fan. For example, FIG. 3 shows a replica championship ring 18 designed to commemorate the New England Patriots 2003 Super Bowl XXXVIII Championship. Accordingly, with respect to the ring 18 of FIG. 3, the group of fans 11 include the 2003 season ticket holders for the New England Patriots professional NFL football team. The ring 18 is a personalized article provided for one of the season ticket holders, namely, Mr. Vinnie DiCesare. A first unique identifier 20 includes the season ticket holder's name “VINNIE DiCESARE” disposed on the ring 18 along with the designation “SEASON TICKET HOLDER 2003”. Additionally, a second unique identifier 22 is included on the ring 18 which includes the corresponding seat number allocated to the particular season ticket holder. As shown in the FIG. 3 example, the second unique identifier 22 includes the terms “GILLETTE STADIUM” followed by the seat identifiers “SECTION 122”, “ROW 13”, and “SEAT 10” which identify the seat corresponding to the season ticket holder identified with the first unique identifier 20. Thus, in the above-described embodiment, the second unique identifier 22 includes a seat identifier includes a section, row, and seat numbers for a particular seat belonging to the particular season ticket holder identified above.

In other embodiments, the season ticket holder may be a corporation wherein the first unique identifier 20 may include the name of the corporation. The term “Patriots” and the design mark shown on the ring 18 are registered trademarks of New England Patriots, L.P. Additionally, the design of the ring 18 as well as other marks thereon may be the subject of copyrights or other trademarks owned by the New England Patriots and/or other organizations. The ring 18 shown herein is included only as an example of a personalized article provided in accordance with the present invention.

In a further embodiment of the present invention, the step of selecting a unique identifier (block 14) corresponding to each fan of the group of fans 11 is performed by the fans, thus each fan selects his/her own unique identifier. For example, a fan might choose a nickname as part of the first unique identifier 20 for the ring 18.

Referring again to FIG. 1, at block 16, the method 10 of the present invention includes offering to each fan of a group of fans 11 a personalized article related to the sports team and bearing unique indicia corresponding to the unique identifier associated with the offeree fan. Typically, one or more articles to be personalized are designed and offered to each fan of the group of fans 11 via a letter, email or other notification. Thereafter, each of the fans of the group of fans 11 is provided an opportunity to accept or decline the offer as set forth at decision block 24. If a fan declines the offer, the method 10 for each declining fan ends at block 26.

For each fan of the group of fans 11 that accepts the offer and is interested in obtaining a personalized article related to the sports team, a sales transaction is completed at block 28 wherein each of the fans accepting the offer purchases one or more of the personalized articles. In other embodiments of the invention, the personalized articles could be promotional or give-away items such that the purchasing step represented at block 28 is omitted.

The personalized articles purchased are ordered at step 30 and delivered to the appropriate fans of the group of fans 11 at step 32. As set forth, in steps 28 and 30 of the method 10, only those personalized articles purchased are ordered, typically, from a manufacturer, distributor or other supplier of the articles to be personalized. Thus, the personalized articles may be a limited edition that are custom made for and available only to the fans of the group of fans 11 that have accepted the offer at block 24. For example, the ring 18 shown in FIG. 3, is a commemorative ring designed specifically for the season ticket holders of 2003 to commemorate the Super Bowl XXXVIII championship and the 2003 team. Thus, the ring 18 was designed for and offered only to the season ticket holders of the 2003 New England Patriots football team. Accordingly, the personalized articles offered to and provided to the group of fans 11 can combine to form a limited edition or commemorative set.

In other embodiments of the method for promoting fan identification with a sports team 10 of the present invention, one or more of the steps 28-30 can be omitted. For example, as set forth above, the sports team may provide a personalized article such as a jacket or cap to each of the season ticket holders as a benefit or reward for being a season ticket holder and therefore a customer and fan of the sports team. The personalized articles bearing unique identifiers corresponding to each of the season ticket holders as set forth above. Thus, the method 10 does not require a step of purchasing or ordering the personalized articles. The method for promoting fan identification with a sports team 10 ends at block 34.

By providing personalized articles available to the group of fans 11 of a sports team, each of the fans of the group are enabled to further identify with the sports team and distinguish themselves from those not in the group. Accordingly, the method of the present invention enables each of the fans of the group of fans 11 to further categorize themselves as a part of the sports team and thereby attain a sense of belonging with the team as well as increased self-esteem. Additionally, personalized articles such as the ring 18 of the present invention provide means for dedicated or enthusiastic fans of a sports team to further share in the experience and celebration of winning a championship or other achievements of the sports team.

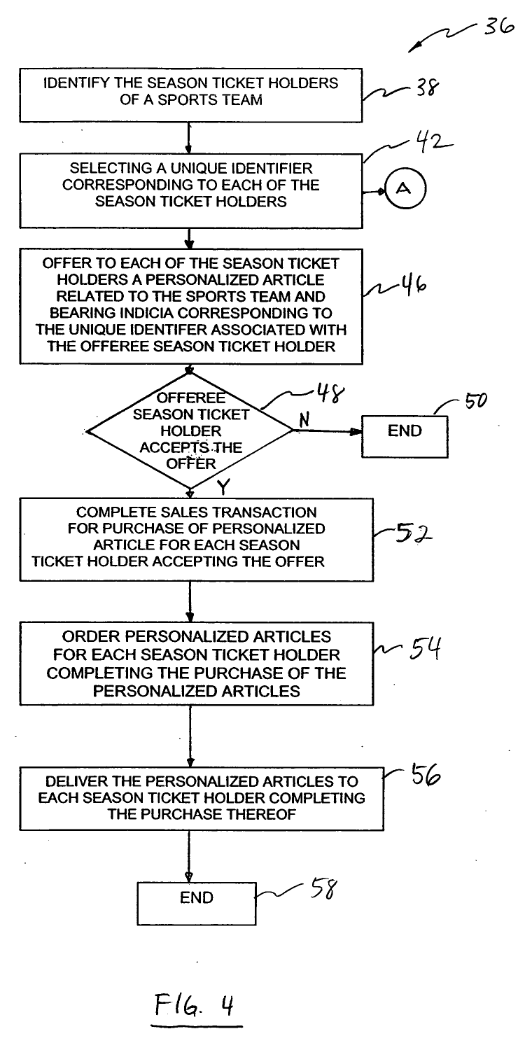

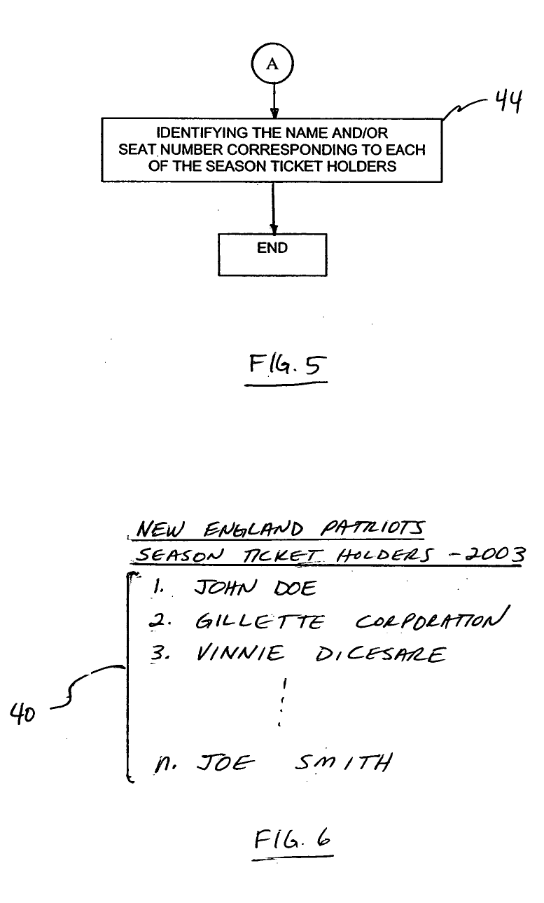

Referring to FIGS. 4 and 5, a flow chart of a preferred embodiment of the method for promoting fan identification with a sports team in accordance with the present invention is shown generally at 36. The method 36 is directed to the season ticket holders associated with the sports team and is typically carried out and utilized by a sports team for the purpose of increasing the level of identification the season ticket holders have with the sports team. A third party could also utilize the method 36 of the present invention on behalf of a sports team.

Referring to FIG. 4, the method 36 begins at block 38 wherein at least a portion of the season ticket holders 40 (shown in FIG. 6) of a sports team are identified. At block 42, a unique identifier is selected for each of the n season ticket holders 40. As discussed above and shown at block 44 of FIG. 5, the unique identifier can include a first unique identifier 20 including the season ticket holder's name and a second unique identifier 22 referencing the season ticket holder' seat number in a stadium associated with the sports team. However, the present invention is not limited in this regard as any unique identifier can be selected for each of the n season ticket holders 40. Alternatively, the season ticket holders 40 can select their own unique identifier.

In a further embodiment, the unique identifier for each season ticket holder can be a “license number” formed from the seat identifier associated with the season ticket holders 40 seat(s) in the stadium or arena where the sports team plays in home games. For example, the license number 122.13.10 could be a unique identifier for the season ticket holder 40 owning the seat at section 122, row 13, and seat 10. Thus, the season ticket holder 40 can purchase various articles, including clothing, caps, etc., each bearing team logos and year indicia as well as the season ticket holders name or family name and/or license number. Accordingly, a season ticket holder's motivation to become or stay involved with the team can is increased by maintaining the availability of the personalized articles only to the season ticket holders of the team. Thus, the sports team benefits by creating a motivation for season ticket holders to maintain and continue purchasing season tickets, and the season ticket holders 40 benefits through the increased sense of belonging and identification with the sports team gained through the personalized articles made available to them. Further, certain season ticket holders 40 will start collections of the personalized articles for each year or consecutive events wherein the season ticket holder individually or his/her entire family can become involved and encouraged to maintain the season tickets such that the collection of personalized articles is complete and ongoing.

At blocks 46 and 48 each of the season ticket holders 40 is offered a personalized article relating to the sports team or an event associated therewith and is provided an opportunity to either accept or decline the offer as discussed above. Each of the personalized articles bearing indicia corresponding to the unique identifier for the season ticket holders. The method 36 ends for each of the season ticket holders 40 declining the offer at block 50.

For those season ticket holders 40 accepting the offer, the method continues as set forth above with a sales transaction at block 52 wherein each of the season ticket holders 40 purchases a personalized article, followed by the steps of ordering (block 54) and delivering the personalized articles to each season ticket holder (block 56). The method 36 of the present invention ends at block 58.

In a further embodiment of the method of the present invention for promoting fan identification with a sports team, the season ticket holders of a sports team are notified and offered a membership in a season ticket holders club, whereby only season ticket holders are eligible for membership. The season ticket holders club is an organization operated by the sports team to further enhance the association and identification the season ticket holders with the sports team. For example the sports team could organize meet and greets or other events wherein the season ticket holders could meet certain players, owners or members of the sports team. Accordingly, through membership in the club, the season ticket holders are encouraged to continue purchasing season tickets so that their membership in the season ticket holders club is maintained.

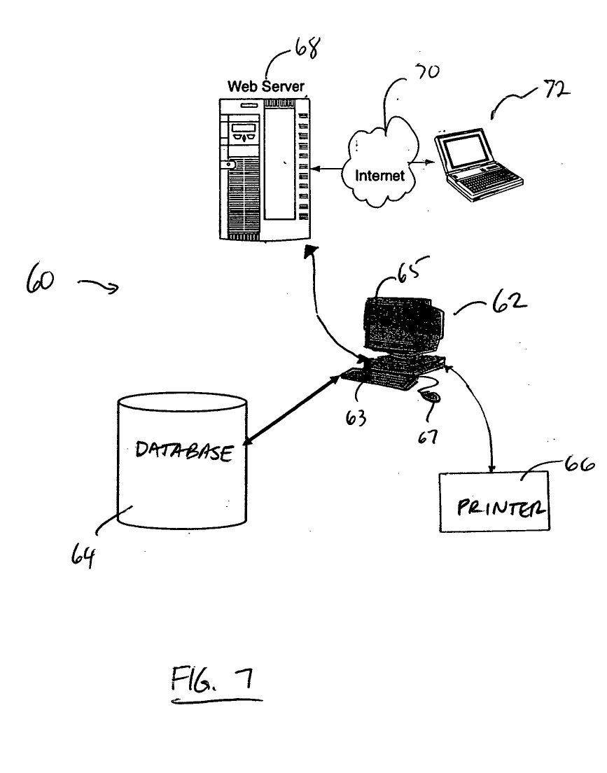

Referring to FIG. 7, an exemplary embodiment of a schematic block diagram of a computer system in accordance with the present invention is shown generally at 60. The computer system 60 includes a computer 62 having a keyboard 63, monitor 65 and mouse 67 attached thereto. The computer 62 is coupled to a database 64 and printer 66. The database 64 contains stored data corresponding to one or more groups of fans 11 of a sports team such as season ticket holders 40. The computer 62 includes one or more software applications for reading a data file corresponding to a group of fans 11, identifying a unique identifier corresponding to each fan of the group and generating offers to each fan of the group. The offers including offering to each fan of the group one or more personalized article related to the sports team or an event associated therewith. The personalized articles each bearing indicia associated with the the unique identified corresponding to each fan of the group. The unique identifier for each fan of the group of fans 11 can be selected from the stored data corresponding to the particular fan. The offers generated can be output via the printer 64 and forwarded to each fan of the group or electronically via a web server 68 and network 70 to a client or fan computer 72. Additionally, the computer system 60 is coupled to the webserver 68 such that fans of the group 11 may respond to the offers electronically through a fan computer 72 and the network 70 via an electronic message directed to the computer 62.

The computer 62 further comprises software applications for completing sales transactions for the personalized items with the fans of the group 11. Additionally, the computer 62 includes software for communicating with and transmitting purchase orders or requests to suppliers of the personalized articles for carrying out the personalization and delivery of the personalized articles to the appropriate fans of the group of fans 11.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A method for promoting fan identification with a sports team, the method comprising the steps of:
identifying a group of fans of a sports team;
selecting a unique identifier corresponding to each of the fans of the group;
offering to each fan of the group a personalized article related to the sports team or an event associated therewith, each of the personalized articles bearing indicia corresponding to the unique identifier associated with the offeree fan;
providing the personalized articles to each fan of the group accepting the offer.

2. The method of claim 1 wherein the step of offering further comprises an offer to sell the personalized articles to each of the fans of the group.

3. The method of claim 1 wherein the step of identifying a group of fans includes identifying a plurality of season ticket holders of the sports team.

4. The method of claim according to claim 3 wherein the step of selecting a unique identifier includes identifying a seat identifier associated with each of the season ticket holders.

5. The method of claim 2 further comprising a step of selling a corresponding one of the personalized articles to at least one fan of the group.

6. The method of claim 1 further comprising a step of delivering a corresponding one of the personalized articles to at least one fan of the group.

7. The method of claim 1 wherein the step of offering includes offering a personalized championship ring or replica thereof to each fan of the group.

8. The method of claim 1 wherein the step of offering includes offering at least one of a personalized piece of jewelry, a personalized article of clothing or headwear, and a personalized article of manufacture to each fan of the group.

9. The method of claim 1 further comprising a step of providing a limited edition set of personalized articles wherein the personalized articles offered to each fan of the group of fans combine to form the limited edition set.

10. The method of claim 1 further comprising a step of providing a commemorative set of personalized articles corresponding to an event associated with the sports team wherein the personalized articles offered to each fan of the group of fans combine to form the commemorative set.

11. A computer implemented system for promoting fan identification with a sports team, the method comprising the steps of:
means for identifying a group of fans of a sports team;
means for selecting a unique identifier corresponding to each of the fans of the group;
means for offering to each fan of the group of fans, a personalized article related to the sports team or an event associated therewith, each of the personalized articles bearing indicia corresponding to the unique identifier associated with the offeree fan;
means for providing the personalized articles for each fan of the group accepting the offer.

12. The system for promoting fan identification with a sports team according to claim 11, wherein the means for identifying a group of fans of a sports team includes means for identifying at least a portion of the season ticket holders of the sports team.

13. The system for promoting fan identification with a sports team according to claim 12, wherein the means for selecting a unique identifier corresponding to each of the fans of the group, includes identifying the seat number associated with each of the portion of the season ticket holders.
